(19) United States
(12) Patent Application Publication
(10) Pub. No.: US 2010/0078893 A1
(43) Pub. Date: Apr. 1, 2010

(54) ACTIVE RETRACTABLE SEAL FOR TURBOMACHINERY AND RELATED METHOD

(75) Inventors: Norman Arnold Turnquist, Sloansville, NY (US); Shorya Awtar, Ann Arbor, MI (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/241,407

(22) Filed: Sep. 30, 2008

(51) Int. Cl. F16J 15/447

(52) U.S. Cl. 277/303; 277/413

(57) ABSTRACT

An active retractable seal assembly is configured for use between a rotating component and a stationary component of turbo machinery is disclosed. The seal assembly includes a seal mounted to the stationary component. The seal is movable towards and away from the rotating component between a respective closed position and an open position as a function of pressure drop across the seal. The seal includes an active seal segment, a non-active seal segment, and a fluid by-pass circuit. The fluid by-pass circuit is configured for directing fluid around the active seal segment to reduce pressure drop across the active seal segment thereby resulting in the active seal segment moving towards an open position under the action of one or more biasing devices while maintaining the non-active seal segment in a closed position.

### BACKGROUND

The invention relates generally to retractable seals for rotary machines, such as steam turbines, and more particularly to an active retractable seal that can be retracted at any time during operation of a machine.

Sealing systems are used in rotary machines such as turbines, compressors, or the like to reduce leakage of fluid flowing through the rotary machines. Fluid leakage through the rotary machines is generally undesirable for various reasons. For example, fluid leakage between the rotor and a circumferentially surrounding casing of a turbine or compressor may lower the efficiency of the turbine or compressor leading to reduced efficiency and increased fuel costs.

Efficiency of rotary devices utilized for pumping a fluid or compressing a vapor (e.g. gas) depends upon the internal tolerances of the components comprising the device. A loosely-toleranced rotary pump or compressor may have a relatively poor fit between internal components and may therefore exhibit poor efficiency, with relatively high leakage occurring within the device from regions of high pressure to regions of lower pressure. The traditional approach to this situation is to decrease the amount of clearance on these critical interfaces.

To reduce the leakage of fluid in rotary turbines or compressors, labyrinth seals or honeycomb seals are sometimes used. Sealing strips in such arrangements are typically disposed between the rotor and the stationary casing. The effectiveness of the seal depends on maintaining a desired clearance between the sealing strips and the rotor. If the clearance exceeds a desired amount, efficiency of the compressor is lowered. Running clearances may deviate from design intent due to misalignment between rotor and casing and during transients, such as start-up, the rotor may expand relative to the casing or sweep through orbits, causing the rotor and stationary components to interfere (i.e., contact one another). As a result, seal components that are provided on the rotor as well as the stator may be damaged.

One means of reducing the negative effects of rubs or contact during transient events has been to employ the variable clearance “positive-pressure-packing” (VCPPP) arrangement, in which springs are used to hold the seal segments open at a large running clearance under no or low-flow transient conditions, when such rubbing is most likely to occur. During steady-state conditions, when the machine is typically operating at a higher load with higher fluid pressures, the ambient pressure around the seal segment overcomes the spring force acting to close the rings to a close running clearance.

However, the variable clearance positive-pressure arrangement responds solely to the machine load. Once the machine reaches a design load, the packing ring segments close and remain closed until the machine load, and therefore the fluid pressure inside the machine, drops adequately. Thermal transients may persist, however, even after the design load has been reached. Furthermore, the seals are susceptible to rubbing in case of rotor vibrations during steady-state operation, when the seal segments are forcibly closed by the ambient fluid pressure. In such circumstances, the known arrangement is not effective in avoiding rubs since it is a passive method for positioning the seal segments.

It would be desirable to provide an “actively controlled” seal positioning arrangement in which the seal arrangement is held open not just during no or low-flow conditions, which correspond to the start-up and shut-down transients, but can be opened at any other operating condition, when rubbing might occur, and for any desired period of time.

### BRIEF DESCRIPTION

In accordance with one exemplary embodiment of the present invention, an active retractable seal assembly configured for use between a rotating component and a stationary component of turbo machinery is disclosed. The seal assembly includes a seal mounted to the stationary component. The seal is radially movable towards and away from the rotating component between a respective closed position and an open position as a function of pressure drop across the seal. The seal includes an active seal segment, a non-active seal segment, and a fluid by-pass circuit. The fluid by-pass circuit is configured for directing fluid around the active seal segment to reduce pressure drop across the active seal segment thereby resulting in the active seal segment moving towards an open position under the action of one or more biasing devices while maintaining the non-active seal segment in a closed position.

In accordance with another exemplary embodiment of the present invention, an active retractable seal assembly configured for use between a rotor and a stator of a turbine is disclosed.

In accordance with another exemplary embodiment of the present invention, an active retractable seal assembly configured for use between a rotating component and a stationary component of turbo machinery is disclosed. The seal assembly includes a seal mounted to the stationary component. The seal is radially movable towards and away from the rotating component between a respective closed position and an open position as a function of pressure drop across the seal. The seal includes an active seal segment, a non-active seal segment, and a fluid by-pass circuit. The active seal segment is disposed radially within the non-active seal segment. The active seal segment is movable towards and away from the rotating component between a respective closed position and an open position relative to the non-active seal segment. The fluid by-pass circuit is configured for directing fluid around the active seal segment to reduce pressure drop across the active seal segment thereby resulting in the active seal segment moving towards an open position under the action of one or more biasing devices while maintaining the non-active seal segment in a closed position.

In accordance with another exemplary embodiment of the present invention, a method for actively controlling a seal mounted to a stationary component and movable towards and away from a rotating component between a respective closed position and an open position as a function of pressure drop across the seal in a turbo machinery is disclosed.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of a turbo machinery, e.g. steam turbine having a turbine bucket and a seal assembly in accordance with an exemplary embodiment of the present invention;

FIG. 2 is a diagrammatical representation of a seal assembly having a segment packing ring in accordance with an exemplary embodiment of the present invention;

FIG. 3 is a diagrammatical representation of a seal assembly having a segment packing ring in accordance with another exemplary embodiment of the present invention; and

FIG. 4 is a diagrammatical representation of a seal assembly having a segment packing ring in accordance with yet another exemplary embodiment of the present invention.

### DETAILED DESCRIPTION

With reference to the embodiments discussed below, an active retractable seal assembly configured for use between a rotating component and a stationary component is disclosed. The seal assembly includes a seal mounted to the stationary component. The seal is movable towards and away from the rotating component between a respective closed position and an open position as a function of pressure drop across the seal. The seal includes a non-active seal segment, an active seal segment, and a fluid by-pass circuit. The fluid by-pass circuit is configured for directing fluid around the active seal segment to reduce pressure drop across the active seal segment thereby resulting in the active seal segment moving towards an open position under the action of one or more biasing devices while maintaining the non-active seal segment in a closed position. The active retractable concept allows the active seal segment to be retracted at any time during the operation of a turbo-machine by providing a fluid flow by-pass that neutralizes the pressure drop across the active seal segment. The radially inward fluid-pressure force on the active seal segment is effectively reduced and the active seal segment can be made to retract radially outward either using springs or low force capacity actuators by eliminating or reducing the pressure drop across the active seal segment.

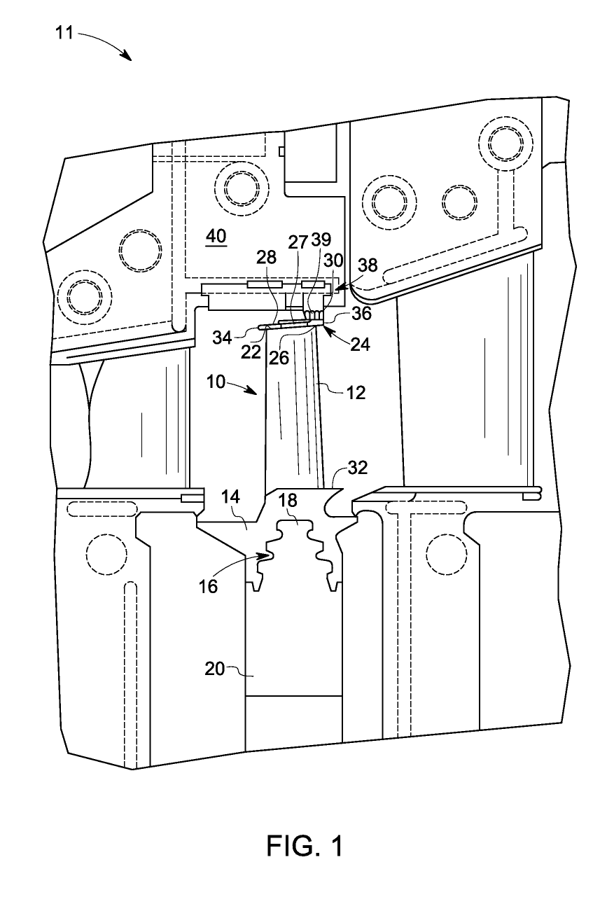

With reference to FIG. 1, a turbomachinery, for example, a steam turbine 11 includes a steam turbine bucket 10 (rotating component) having an airfoil portion 12 and a shank portion 14. The shank portion 14 includes a female attachment portion 16 that is adapted to be coupled with a male attachment portion 18 of a wheel 20 on a turbine rotor. It will be appreciated that, for purposes of this invention, the manner in which the bucket 10 is secured to the rotor wheel, however, is not limited to the illustrated embodiment but includes all suitable equivalent securing techniques.

A radially outer tip of the airfoil portion 12 is defined by an edge 22, which is engaged by a bucket cover 24. Edge 22 is also provided with a radially outward extending tenon 27 that receives the bucket cover 24 via an opening therein. A radially inner surface 26 of the bucket cover 24 is seated on the edge 22 of the airfoil portion 12. Note in this regard that front and back edges 34, 36 of the bucket cover 24 are substantially perpendicular to the radially inner and outer surfaces 26, 28 of the bucket cover 24. An active retractable seal assembly 38 is movably coupled to a stationary component (stator or casing) 40 and disposed radially outward of the bucket cover 24. The seal assembly 38 includes a plurality of seal teeth 42 arranged in a substantially horizontal array relative to said radially outer surface 28 of the bucket cover 24. The radially outer surface 28 of the bucket cover 24 lies in a plane substantially parallel to the substantially horizontal array of seal teeth 39. The details of the seal assembly are described in greater detail with reference to subsequent figures. Embodiments of the invention are not limited, however, to any particular labyrinth teeth arrangement. In fact, the seal arrangement described herein is applicable to all kinds of seals, including but not limited to labyrinth packings (including straight tooth, slant tooth and Vernier packings), brush seals, compliant plate seals, shingle seals, honeycomb seals, and abradable seals. The seal arrangement is also applicable at any sealing location including but not limited to end packings, inter-stage sealing, tip sealing, or the like.

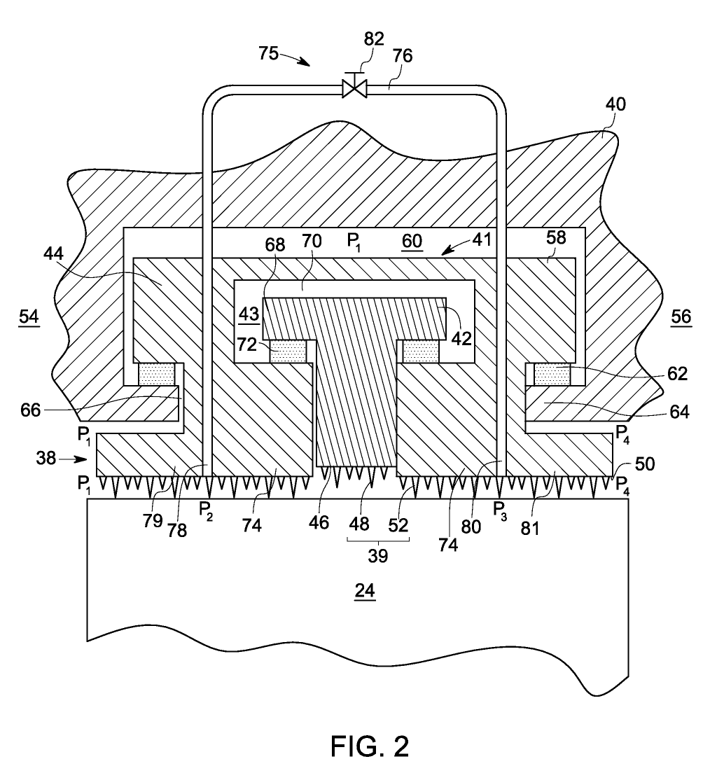

Referring to FIG. 2, the seal assembly 38 disposed between the bucket cover 24 and the stationary casing 40 is illustrated. In the illustrated embodiment, the seal assembly 38 includes a seal or packing ring 41 having an active seal segment 42 movably disposed radially within a cavity 43 of a non-active seal segment 44. The active seal segment 42 includes a sealing face 46 having teeth 48 projecting radially inwardly therefrom towards the bucket cover 24. The non-active seal segment 44 includes a sealing face 50 having teeth 52 projecting radially inwardly therefrom towards the bucket cover 24. The seal assembly 38 provides a barrier between a high-pressure region 54 and a low-pressure region 56 of the steam turbine. Typically, the seal segment functions by presenting a relatively large number of barriers (e.g., teeth 48, 52) between the casing 40 and the bucket cover 24 to the flow of fluid from the high-pressure region 54 to the low-pressure region 56.

In the illustrated embodiment, the non-active seal segment 44 includes a flanged portion 58 opposite the sealing face 50. A packing head cavity 60 is formed between the flanged portion 58 of the non-active seal segment 44 and the casing 40. Biasing devices 62 such as springs are disposed between the flanged portion 58 and a hook portion 64 of the casing 40. The non-active seal segment 44 is capable of radial inward and outward movement. In other words, the non-active seal segment 44 may be moved towards and away from the bucket cover 24. The biasing devices 62 nominally bias the non-active seal segment 44 to a radially retracted or open position. It should be noted herein that “open position” may be referred to as a position in which the seal segment does not contact the bucket cover 24 and “closed position” may be referred to as a position in which the seal segment contacts the bucket cover 24. These biasing devices 62 hold the non-active seal segment 44 in an open or retracted position during unloaded no- or low-flow conditions, such as startup or shutdown. As the turbine is brought up to an operating load, the upstream high-pressure process fluid (e.g., steam or the gaseous products of combustion) enters the cavity 60 via gaps 66 or other features, such as conventionally arranged feed holes, such that the pressure force (PI) overcomes the spring force, moving the non-active seal segment 44 radially inwards toward the bucket cover 24 to a close running clearance.

In the illustrated embodiment, the active seal segment 42 includes a flanged portion 68 opposite the sealing face 46. A packing head cavity 70 is formed between the flanged portion 68 of the active seal segment 42 and the non-active seal segment 44. Biasing devices 72 such as springs are disposed between the flanged portion 68 and a hook portion 74 of the non-active seal segment 44. The active seal segment 42 is capable of radial inward and outward movement. In other words, the active seal segment 42 may be moved towards and away from the bucket cover 24. The biasing devices 72 bias the active seal segment 42 to a radially retracted or open position. The biasing devices 72 hold the active seal segment 42 in an open or retracted position during unloaded no- or low-flow conditions, such as startup or shutdown. As discussed previously, when the turbine is brought up to an operating load, the pressure force (PI) overcomes the spring force, moving the non-active seal segment 44 radially inwards toward the bucket cover 24. This results in the active seal segment 42 also being pushed towards the bucket cover 24.

The seal assembly also includes a fluid by-pass circuit 75 that includes at least one conduit or pipe 76 having an inlet 78 disposed at a upstream location 79 of the active seal segment 42 and an outlet 80 disposed at a downstream location 81 of the active seal segment 42. The conduit 76 may extend from the upstream location 79 to the downstream location 81 of the active seal segment 42 via the stationary casing 40. The configuration of the circuit 75 may vary depending on the application. The conduit 76 is provided with at least one by-pass control valve 82 located between the inlet 78 and outlet 80 for controlling flow of fluid through the by-pass circuit 75. The valve 82 may be operated manually or automatically. Automatic operation can be either direct or in conjunction with a machine controller. When the valve 82 is opened, the by-pass flow conduit 76 offers significantly less resistance to flow as compared to the leakage between the seal rings and the bucket cover 24. In other words, when the valve 82 is opened, the by-pass circuit 75 facilitates to equalize the pressure force P2 and P3 allowing the active seal segment 42 to open with respect to the non-active seal segment 44. The circuit 75 directs the fluid around the active seal segment 42 to reduce pressure drop across the active seal segment 42 which causes the active seal segment 42 to retract, i.e., open, under the influence of biasing devices 72. When the valve 82 is closed, the active seal segment 42 may be moved to a closed position.

In accordance with the illustrated embodiment of the present invention, seal segments (for example labyrinth teeth) make be retracted away from the bucket cover 24 whenever a rub is suspected. This action allows preserving the teeth quality, and thereby retaining good sealing performance over long periods of time. The retraction of seal segments is achieved by biasing devices such as springs that nominally pull the seal segments away from bucket tips in the absence of a pressure load, and a flow by-pass circuit 75 that neutralizes the pressure load. It should also be noted that the packing ring 41 is segmented. For a typical bucket tip location, where there is space only for a single packing ring, by-passing fluid around this single packing ring in order to retract the packing ring is impractical because this also eliminates the stage pressure drop which is necessary for the fluid to perform work on a rotor. However, in accordance with illustrated embodiment, if the packing ring is segmented into two or more segments, the flow by-pass circuit 75 can be disposed around the active seal segment 42 so that the non-active segment 44 can provide somewhat compromised yet necessary sealing at the bucket tip when the active seal segment 42 is retracted. The valve 82 provided on the by-pass conduit 76 is used to open or close the active seal segment 42. Opening of the active seal segment 42 is achieved by opening the by-pass valve 82, which neutralizes the pressure drop across the active seal segment 42, and closing is achieved by closing the by-pass valve 82, which resumes the pressure drop across the active seal segment 42.

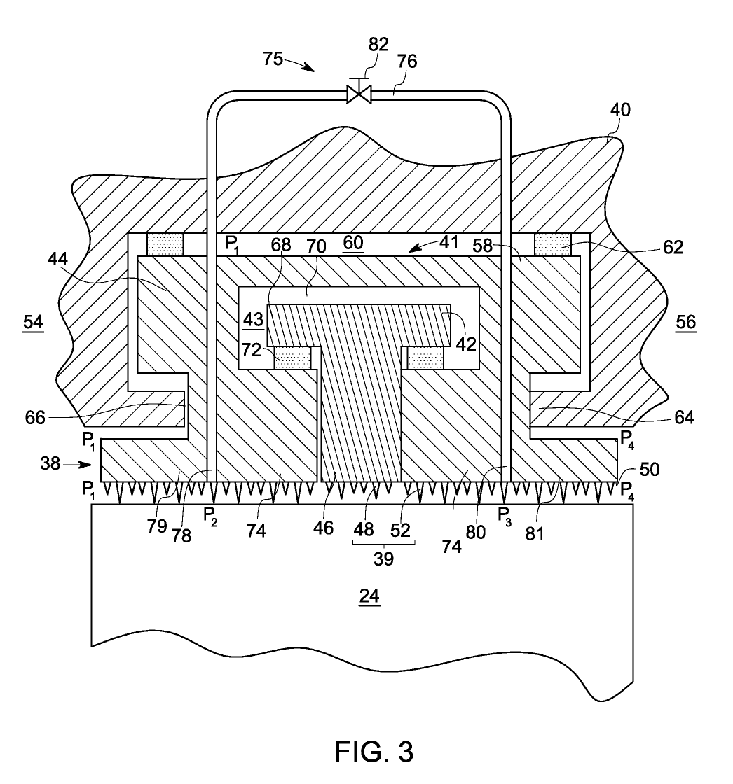

Referring to FIG. 3, another embodiment of the seal assembly 38 disposed between the bucket cover 24 and the stationary casing 40 is illustrated. In the illustrated embodiment, the seal assembly 38 includes the seal or packing ring 41 having the active seal segment 42 movably disposed radially within the cavity 43 of the non-active seal segment 44. The seal assembly 38 provides a barrier between a high-pressure region 54 and a low-pressure region 56 of the steam turbine. In the previous embodiment, the biasing devices 62 such as springs are disposed between the flanged portion 58 and a hook portion 64 of the casing 40. In contrast, in the illustrated embodiment, the biasing devices 62 are disposed in the packing head cavity 60 formed between the flanged portion 58 of the non-active seal segment 44 and the casing 40. The non-active seal segment 44 is capable of radial inward and outward movement. The biasing devices 62 nominally bias the non-active seal segment 44 to closed position. In the illustrated embodiment, there is no biasing force to hold the non-active seal segment 44 in an open or retracted position during unloaded no- or low-flow conditions. When the turbine is subjected up to an operating load, the pressure force (PI) and the force of the biasing devices 62 bias the non-active seal segment 44 radially inwards toward the bucket cover 24.

Similar to the previous embodiment, the biasing devices 72 are disposed between the flanged portion 68 of the active seal segment 42 and a hook portion 74 of the non-active seal segment 44. The biasing devices 72 bias the active seal segment 42 to a radially retracted or open position. The fluid by-pass circuit 75 is disposed extending around the active seal segment 42. When the valve 82 is opened, the by-pass circuit 75 facilitates to equalize the pressure force P2 and P3 allowing the active seal segment 42 to open with respect to the non-active seal segment 44. The circuit 75 directs the fluid around the active seal segment 42 to reduce pressure drop across the active seal segment 42 which causes the active seal segment 42 to retract, i.e., open, under the influence of biasing devices 72. In the illustrated embodiment, the force of the biasing devices 62 constantly biases the non-active seal segment 44 towards the closed position. This may cause abrasion of the teeth but ensures adequate sealing performance.

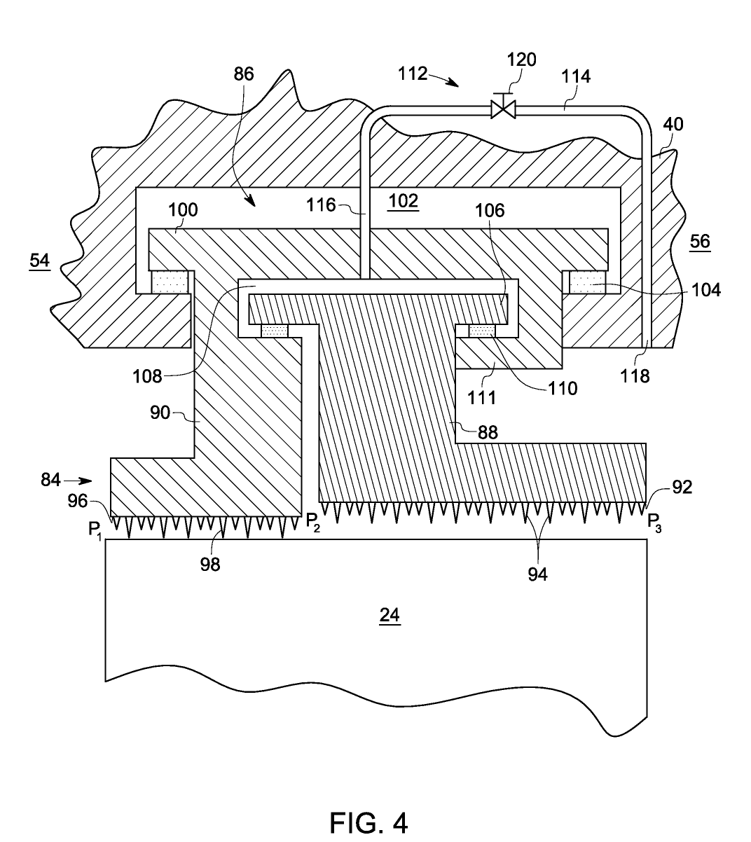

Referring to FIG. 4, another embodiment of a seal assembly 84 disposed between the bucket cover 24 and the stationary casing 40 is illustrated. In the illustrated embodiment, the seal assembly 84 includes a seal or packing ring 86 having an active seal segment 88 movably disposed radially inwards with respect to a non-active seal segment 90. It should be noted herein that in the illustrated embodiment, the active seal segment 88 is not entirely disposed within the non-active seal segment 90 as compared to the embodiments illustrated in FIGS. 2 and 3. The active seal segment 88 includes a sealing face 92 having teeth 94 projecting radially inwardly therefrom towards the bucket cover 24. The non-active seal segment 90 includes a sealing face 96 having teeth 98 projecting radially inwards therefrom towards the bucket cover 24. The seal assembly 84 provides a barrier between a high-pressure region 54 and a low-pressure region 56 of the steam turbine.

In the illustrated embodiment, the non-active seal segment 90 includes a flanged portion 100 opposite the sealing face 96. A packing head cavity 102 is formed between the flanged portion 100 of the non-active seal segment 90 and the casing 40. Biasing devices 104 such as springs are disposed between the flanged portion 100 and the hook portion 64 of the casing 40. The biasing devices 104 nominally bias the non-active seal segment 90 to a radially retracted or open position. The biasing devices 104 hold the non-active seal segment 90 in an open or retracted position during unloaded no- or low-flow conditions, such as startup or shutdown when the turbine is brought up to an operating load, the pressure force (PI) overcomes the spring force of the biasing devices 104, moving the non-active seal segment 90 radially inwardly toward the bucket cover 24.

In the illustrated embodiment, the active seal segment 88 includes a flanged portion 106 opposite the sealing face 92. A packing head cavity 108 is formed between the flanged portion 106 of the active seal segment 88 and the non-active seal segment 90. Biasing devices 110 such as springs are disposed between the flanged portion 106 and a hook portion 111 of the non-active seal segment 90. The biasing devices 110 bias the active seal segment 88 to a radially retracted or open position. The biasing devices 110 hold the active seal segment 88 in an open or retracted position during unloaded no or low-flow conditions. When the turbine is brought up to an operating load, the pressure force (PI) overcomes the spring force, moving the non-active seal segment 90 radially inwards toward the bucket cover 24. This results in the active seal segment 88 also being pushed towards the bucket cover 24.

The seal assembly 84 further includes a fluid by-pass circuit 112 that includes at least one conduit 114 having an inlet 116 disposed at the non-active seal segment 90 and an outlet 118 disposed at the stationary casing 40. It should be noted herein the circuit 112 is disposed extending around the active seal segment 88. The conduit 114 is provided with at least one by-pass control valve 120 located between the inlet 116 and outlet 118 for controlling flow of fluid through the by-pass circuit 112. In the illustrated embodiment, when the valve 120 is opened, the by-pass circuit 112 facilitates to equalize the pressure force P2 and P3 allowing the active seal segment 88 to open with respect to the non-active seal segment 90. The circuit 112 directs the fluid around the active seal segment 88 to reduce pressure drop across the active seal segment 88 which causes the active seal segment 88 to retract, i.e., open, under the influence of biasing devices 110. When the valve 120 is closed, the active seal segment 88 may be moved to a closed position. It should also be noted herein that in the embodiments described herein multiple independent by-pass circuits are also envisaged.

In some embodiments, the biasing devices 104 are disposed in the packing head cavity 102 formed between the flanged portion 100 of the non-active seal segment 90 and the casing 40. The non-active seal segment 90 is capable of radial inward and outward movement. The biasing devices 104 nominally bias the non-active seal segment 90 to closed position. In such embodiments, there is no biasing force to hold the non-active seal segment 90 in an open or retracted position during unloaded no- or low-flow conditions. When the turbine is subjected up to an operating load, the pressure force (PI) and the force of the biasing devices 104 bias the non-active seal segment 90 radially inwards toward the bucket cover 24.

In another embodiment, the seal assembly may include a segmented brush seal having an active segment and a non-active segment. In another embodiment, the seal assembly may include a brush seal may be incorporated within a traditional labyrinth packing seal. The brush seal may be a non-active segment and packing ring may be an active segment, and vice versa. In yet another embodiment, the seal assembly may include a segmented compliant plate seal in which one segment is active and the other is non-active. In some embodiments, the seal assembly may include a plate seal incorporated within a labyrinth packing seal. The plate seal may be a non-active segment and packing ring may be an active segment, and vice versa. In certain embodiments, the seal assembly may include a segmented seal ring having an abradable coating or honeycomb type seal elements. The manner in which an active segment moves to closed and open positions is similar to the embodiments described with reference to FIGS. 1-4.

The use of active retractable seals has several benefits and advantages. For example, the exemplary concept enables the retraction of active seal segments under any machine operating condition such as start-up, speed ramp-up, load ramp-up, forward-flow/reverse-flow, steady state operation, shut-down or trip. Also, as already noted, the by-pass circuit to retract active seal segments disclosed herein is applicable to all turbo machinery including but not limited to steam and gas turbines, compressors, aircraft engines, or the like.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An active retractable seal assembly configured for use between a rotating component and a stationary component of a turbomachinery, comprising:
a seal mounted to the stationary component, wherein the seal is movable towards and away from the rotating component between a respective closed position and an open position as a function of pressure drop across the seal; the seal comprising:
an active seal segment;
a non-active seal segment; and
a fluid by-pass circuit for directing fluid around the active seal segment to reduce pressure drop across the active seal segment thereby resulting in the active seal segment moving towards an open position under the action of one or more biasing devices while maintaining the non-active seal segment in a closed position.

2. The seal assembly of claim 1, further comprising one or more first biasing devices disposed between the non-active seal segment and the stationary component.

3. The seal assembly of claim 2, wherein the one or more first biasing devices are configured for biasing the non-active seal segment towards a closing position in which the non-active seal segment contacts the rotating component.

4. The seal assembly of claim 2, wherein the one or more first biasing devices are configured for biasing the non-active seal segment towards an open position in which the non-active seal segment does not contact the rotating component.

5. The seal assembly of claim 1, further comprising one or more second biasing devices disposed between the active seal segment and the non-active seal segment.

6. The seal assembly of claim 5, wherein the one or more second biasing devices are configured for biasing the active seal segment towards an open position in which the active seal segment does not contact the rotating component.

7. The seal assembly of claim 1, wherein the active seal segment is disposed radially inward within the non-active seal segment.

8. The seal assembly of claim 1, wherein the by-pass circuit comprises a conduit extending from a location upstream of the active seal segment, via the stationary component, to a location downstream of the active seal segment.

9. The seal assembly of claim 8, wherein the by-pass circuit comprises a manually or automatically controlled valve coupled to the conduit and configured to control flow of fluid through the conduit.

10. The seal assembly of claim 9, wherein the active seal segment is moved to an open position by opening the valve.

11. The seal assembly of claim 9, wherein the active seal segment is moved to a closed position by closing the valve.

12. An active retractable seal assembly configured for use between a rotor and a stator of a turbine, comprising:
a seal mounted to the stator, wherein the seal is movable towards and away from the rotor between a respective closed position and an open position as a function of pressure drop across the seal; the seal comprising:
an active seal segment;
a non-active seal segment; and
a fluid by-pass circuit for directing fluid around the active seal segment to reduce pressure drop across the active seal segment thereby resulting in the active seal segment moving towards an open position under the action of one or more biasing devices while maintaining the non-active seal segment in a closed position.

13. The seal assembly of claim 12, wherein the active seal segment comprises an abradable active seal segment.

14. The seal assembly of claim 12, wherein the non-active seal segment comprises an abradable non-active seal segment.

15. The seal assembly of claim 12, wherein the active seal segment is disposed radially inward within the non-active seal segment.

16. The seal assembly of claim 12, wherein the by-pass circuit comprises a conduit extending from a location upstream of the active seal segment, via the stator, to a location downstream of the active seal segment.

17. The seal assembly of claim 12, wherein the by-pass circuit comprises a conduit extending from the non-active seal segment to the stator.

18. The seal assembly of claim 17, wherein the by-pass circuit comprises a manually or automatically controlled valve coupled to the conduit and configured to control flow of fluid through the conduit.

19. The seal assembly of claim 18, wherein the active seal segment is moved to an open position by opening the valve.

20. The seal assembly of claim 18, wherein the active seal segment is moved to a closed position by closing the valve.

21. An active retractable seal assembly configured for use between a rotating component and a stationary component of a turbomachinery, comprising:
a seal mounted to the stationary component, wherein the seal is movable towards and away from the rotating component between a respective closed position and an open position as a function of pressure drop across the seal; the seal comprising:
a non-active seal segment;
an active seal segment disposed radially within the non-active seal segment; wherein the active seal segment is movable towards and away from the rotating component between a respective closed position and an open position relative to the non-active seal segment; and
a fluid by-pass circuit for directing fluid around the active seal segment to reduce pressure drop across the active seal segment thereby resulting in the active seal segment moving towards an open position under the action of one or more biasing devices while maintaining the non-active seal segment in a closed position.

22. The seal assembly of claim 21, wherein the active seal segment is movably disposed within a cavity of the non-active seal segment.

23. A method for actively controlling a seal mounted to a stationary component and movable towards and away from a rotating component between a respective closed position and an open position as a function of pressure drop across the seal in a turbomachinery, the method comprising:
establishing a fluid by-pass circuit around an active seal segment of the seal;
controlling the bypass circuit to selectively admit a process fluid through the by-pass circuit to reduce the pressure drop across the active seal segment, resulting in the active seal segment moving away from the rotating component under the action of one or more biasing devices while maintaining contact between a non-active seal segment of the seal and the rotating component.

24. The method of claim 23, wherein controlling the by-pass circuit comprises controlling a valve coupled to a conduit extending from a location upstream of the active seal segment, via the stationary component, to a location downstream of the active seal segment so as to control flow of the fluid through the conduit to reduce the pressure drop across the active seal segment.
